(19) United States
(12) Patent Application Publication
(10) Pub. No.: US 2014/0324992 A1
(43) Pub. Date: Oct. 30, 2014

(54) METHOD AND DEVICE FOR PROMPTING TO SELECT NEW FILE

(71) Applicants: Xiaolong Zhang, Shenzhen (CN); Xing Liang, Shenzhen (CN); Ge Liang, Shenzhen (CN)

(72) Inventors: Xiaolong Zhang, Shenzhen (CN); Xing Liang, Shenzhen (CN); Ge Liang, Shenzhen (CN)

(21) Appl. No.: 13/994,079

(22) PCT Filed: Apr. 28, 2013
(86) PCT No.: PCT/CN13/74994

§ 371 Date: Jun. 13, 2013

(51) Int. Cl. H04L 12/58

(52) U.S. Cl. CPC H04L 51/08
USPC 709/206

(57) ABSTRACT

Examples of the present disclosure provide a method and a device for prompting to select a new file in Instant Messaging (IM). The method includes: receiving, by an IM client, a request for selecting a file to be transmitted; determining, by the IM client, a new file is obtained within a predefined time period before receiving the request; and prompting, by the IM client, whether to select the new file to be transmitted. By employing the technical solution of the present disclosure, selection and transmission of new files, such as, pictures, audios, videos, documents may be more convenient, efficiency may be higher, and user experience may also be improved.

### FIELD

The present disclosure relates to Instant Messaging (IM) techniques, and more particularly, to a method and a device for prompting to select a new file.

### BACKGROUND

In recent years, instant messaging (IM) tools have been accepted by the majority of Internet users and become essential network tools. It should be noted that, network IM tools are widely used not only in usual entertainment, but also in users' work. The IM tools are frequently used by the users to communicate with their friends, colleagues and students in life and work. Therefore, users may put forward higher requirements in ease of use, stability, security and other aspects of IM tools (such as IM software).

With continuous development of IM technologies, WeChat appears. The WeChat is growing steadily as a new product and new application with information transmission mechanism of IM tools. The WeChat supports to rapidly transmit voice short message, video, picture and characters from a WeChat user to another WeChat user, and supports a group chat.

### SUMMARY

Various examples of the present disclosure provide a method and a device for prompting to select a new file in Instant Messaging (IM).

According to one example of the present disclosure, a method for prompting to select a new file in IM includes: receiving by an IM client a request for selecting a file to be transmitted; determining by the IM client a new file is obtained within a predefined time period before receiving the request; and prompting by the IM client whether to select the new file to be transmitted.

According to another example of the present disclosure, an IM client for prompting to select a new file includes an interface, a processor and a memory, in which the interface is configured to receive a request for selecting a file to be transmitted; the memory is configured to save an obtained file at real time; the processor is configured to determine whether a new file is saved in the memory within a predefined time period, before the interface receives the request for selecting the file to be transmitted; when determining the new file is saved in the memory within the predefined time period, the processor is further configured to obtain information of the new file from the memory, and prompt whether to select the new file to be transmitted, according to the obtained information of the new file.

According to another example of the present disclosure, a method for prompting to select a new file in IM includes: receiving by an IM client a request for selecting a file to be transmitted; determining by the IM client new files are obtained within a predefined time period before receiving the request; and prompting by the IM client whether to select a new file to be transmitted, which is obtained within the predefined time period and is relevant with an action attribute of an IM user of the IM client.

The method and device provided by various examples of the present disclosure beneficially enables selection and transmission of new files to become more convenient. Subsequently, efficiency of selection and transmission about new files may be improved, and user experience may also be enhanced.

The features and advantages described in the disclosure are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

Features of the present disclosure are illustrated by way of example and not limited in the following figure(s), in which like numerals indicate like elements, in which:

FIG. 1 is a flowchart illustrating a method for prompting to select a new file, in accordance with an example of the present disclosure.

FIG. 2 is a block diagram illustrating structure of an Instant Messaging (IM) client for prompting to select a new file, in accordance with an example of the present disclosure.

FIG. 3 is a block diagram illustrating structure of the determining module 202 shown in FIG. 2, in accordance with an example of the present disclosure.

FIG. 4 is a block diagram illustrating structure of an IM client for prompting to select a new file, in accordance with another example of the present disclosure.

FIG. 5 is a flowchart illustrating another method for prompting to select a new file, in accordance with another example of the present disclosure.

### DETAILED DESCRIPTION

Hereinafter, the present disclosure will be described in further detail with reference to the accompanying drawings and examples to make the technical solution and merits therein clearer.

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

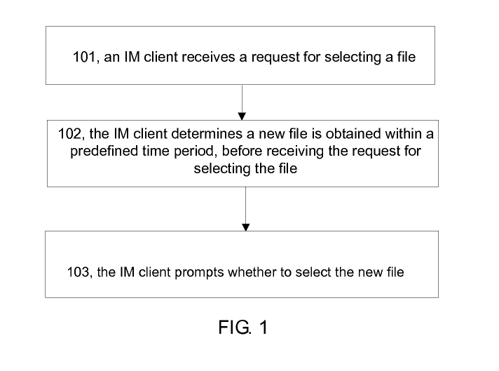

FIG. 1 is a flowchart illustrating a method for prompting to select a new file, in accordance with an example of the present disclosure. As shown in FIG. 1, the method may include the following blocks.

Block 101, an IM client receives a request for selecting a file to be transmitted.

Specifically speaking, when communicating with another IM user, an IM user of the IM client may wish to transmit a file, such as a picture, an audio, a video and a document, to another IM user.

Subsequently, the IM user may firstly transmit a request for selecting a file to be transmitted to the IM client, in which the request may include a type of the file to be selected and transmitted. The type of the file may include at least one of: a picture, an audio, a video and a document.

Block 102, the IM client determines a new file is obtained within a predefined time period, before receiving the request for selecting the file to be transmitted.

When the request for selecting the file to be transmitted received by the IM client in block 101 includes the type of the file to be selected and transmitted, the IM client may determine whether a new file of a same type is obtained within the predefined time period, before receiving the request.

In a first case, suppose the type of the file carried in the request is the picture, the IM client may determine whether a new picture is obtained within the predefined time period, before receiving the request. For example, the predefined time period may be 30 seconds, or 1 minute, which may be set by an IM server according to practical requirements, and are not limited here. Generally speaking, the new picture may be obtained by downloading, or screen capture. In the example, the descriptions are provided, suppose the predefined time period is 30 seconds.

In practical applications, there may be various specific implementation modes for determining whether a new file is obtained within a predefined time period, before receiving the request. For example, when a first new file of a known type is obtained, set a timer, and count down. Under the circumstances that no request for selecting a file to be transmitted is received by the IM client, when the count down process is finished, the first new file may be not provided for subsequent prompting.

Another specific implementation mode may be as follows. When a first new file is obtained, a first time point for obtaining the first new file, a type of the first new file, and an identifier of the first new file may be stored into a database at real time as a record. Similar operations may be executed for a second new file. Subsequently, two records about the first and second new files may be stored into the database according to time sequence. Generally speaking, records about different types of new files may be stored in different places. In the example, suppose the first and second new files are both new pictures, the first time point and the second time point are respectively 10:29:30 a.m., and 10:30:01, a.m.

When the request for selecting the file to be transmitted is received by the IM client, the IM client may record a third time point for receiving the request, and determine a fourth time point using the third time point and the predefined time period. Suppose the third time point is 10:30:30 a.m., and the predefined time period is 30 seconds, the calculated fourth time point may be 10:30:00

Subsequently, the IM client may search in the database for new picture, the obtained time point thereof is in an interval of [10:30:00 a.m., 10:30:30, a.m.). As mentioned above, since the first and second time points are respectively 10:29:30 a.m., and 10:30:01 a.m., the IM client may determine that the second new file, that is, the second new picture is obtained within the predefined time period, before receiving the request for selecting the file to be transmitted.

Suppose the type of the file carried in the request is at least one of an audio, a video and a document, the IM client may also determine whether a new file with the same type carried in the request is obtained within the predefined time period, before receiving the request. The specific operations are similar to the above, which are not repeated here.

In a second case, when the request for selecting the file to be transmitted doesn't include the type of the file, the IM client may determine whether a new file of any type is obtained within the predefined time period, before receiving the request for selecting the file to be transmitted.

It should be noted that, when the IM client determines that no new file is obtained within the predefined time period, before receiving the request for selecting the file to be transmitted. The IM client may provide information about all of the relevant files for the IM user to select, such as all of the pictures, all of the audios, all of the videos and all of the documents stored in the IM client, as in the prior art, which are not repeated here.

Block 103, the IM client prompts whether to select the new file to be transmitted.

In practical applications, when the type of the file carried in the request includes the picture, the IM client may prompt the IM user whether to select the new picture in a manner of thumbnail. When the type of the file carried in the request includes at least one of the audio, the video and the picture, the IM client may prompt the IM user whether to select the new file in a manner of preview.

Generally speaking, in most cases, after an IM user has obtained a new file, the probability for the IM user to select and transmit the new file to another IM user within a short time period is relatively high. By employing the foregoing method, selection and transmission of file may be more convenient, efficiency thereof may also be greatly improved. Subsequently, user experience may be enhanced. In the example illustrated with FIG. 1, the IM user may be a WeChat user, the IM client may be a WeChat client, and the IM server may be the WeChat server.

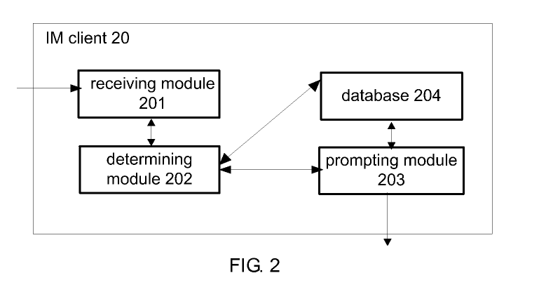

FIG. 2 is a block diagram illustrating structure of an IM client for prompting to select a new file, in accordance with an example of the present disclosure. As shown in FIG. 2, the IM client 20 may include a receiving module 201, a determining module 202, a prompting module 203 and a database 204.

The receiving module 201 is configured to receive a request for selecting a file to be transmitted from an IM user. Specifically speaking, the request may include a type of the file to be selected and transmitted. The type of the file may include at least one of: a picture, an audio, a video and a document.

The determining module 202 is configured to determine whether a new file is obtained within a predefined time period, before the receiving module 201 receives the request for selecting the file to be transmitted from the IM client.

In a first case, when the request for selecting the file to be transmitted received by the receiving module 201 includes the type of the file, such as the picture, the determining module 202 may determine whether a new picture is obtained within the predefined time period, before the receiving module 201 receives the request for selecting the file to be transmitted. For example, the predefined time period may be set as 30 seconds, which may be set according to practical requirements, and are not limited here.

In a second case, when the request for selecting the file to be transmitted received by the receiving module 201 doesn't include the type of the file, the determining module 202 may determine whether a new file of any type is obtained within the predefined time period, before the receiving module 201 receives the request for selecting the file to be transmitted.

In practical applications, there may be various modes for the determining module 202 to determine whether a new file is obtained within the predefined time period, before the receiving module 201 receives the request for selecting the file to be transmitted. In the following, to facilitate understanding, a specific implementation mode is provided.

Specifically speaking, when the determining module 202 determines that there is at least one new file is obtained within the predefined time period, before the receiving module 201 receives the request for selecting the file to be transmitted, the prompting module 203 is configured to obtain information about the at least one new file from the database 204.

When the type of the file carried in the request received by the receiving module 201 is the picture, the prompting module 203 may obtain a thumbnail of a new picture, which is obtained within the predefined time period, before the receiving module 201 receiving the request for selecting the file to be transmitted, and provide the thumbnail obtained to prompt the IM user to select.

When the type of the file carried in the request received by the receiving module 201 is at least one of the audio, the video and the document, prompting module 203 is further configured to obtain preview information of at least a new audio, a new video and a new document from the database 204, and provide the obtained preview information for the IM user, so as to prompt the IM user whether to select the new file to be transmitted.

When the IM user selects the new file prompted by the prompting module 203, the new file may be rapidly selected and subsequently transmitted to another IM user. It may be avoided that the new file is selected by the IM user from so many pictures stored in the IM client used by the IM user, file selection and transmission efficiency may be relatively low.

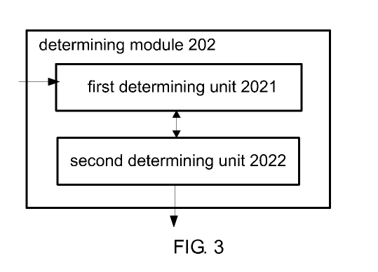

FIG. 3 is a block diagram illustrating structure of the determining module 202 shown in FIG. 2, in accordance with an example of the present disclosure.

As shown in FIG. 3, the determining module 202 may include a first determining unit 2021 and a second determining unit 2022.

Continuing with the example illustrated with FIG. 2, after the receiving module 201 receives the request for selecting a file to be transmitted, the receiving module 201 may transmit the request to the first determining unit 2021. And then, the first determining unit 2021 may determine whether the request received by the receiving module 201 includes a type of the file to be selected and transmitted.

When determining the request includes the type of the file, the first determining unit 2021 may inform the second determining unit 2022 that, the request received by the receiving module 201 includes the type of the file to be selected and transmitted. Subsequently, the second determining unit 2022 may record the time point when the receiving module 201 receives the request, search in the database 204, so as to determine whether a new file of the same type is obtained within the predefined time period, before the receiving module 201 receives the request for selecting the file to be transmitted.

When determining the request doesn't include the type of the file, the first determining unit 2021 may inform the second determining unit 2022 that, the request received by the receiving module 201 doesn't include the type of the file to be selected and transmitted. Subsequently, the second determining unit 2022 may record the time point when the receiving module 201 receives the request, and search in the database 204, so as to determine whether a new file of any type is obtained within the predefined time period, before the receiving module 201 receives the request for selecting the file to be transmitted.

In the example illustrated with FIG. 3, suppose different types of new files are categorized and saved in the database 204 illustrated with FIG. 2. It should be noted that, the new files may also be saved in other parts of the IM client 20, which are not limited here.

In practical applications, there may be various implementation modes for the second determining unit 2022 to determine whether a new file is obtained within the predefined time period, before the receiving module 201 receives the request for selecting the file to be transmitted. For example, once a new file is obtained, the specific time point for obtaining the new file, the type of the new file and an identifier of the new file may be saved at real time in the database 204 as a record. Different records about different new files may be saved into the database 204 according to time sequence. As mentioned above, since the second determining unit 2022 may record a first time point when the receiving module 201 receives the request for selecting the file to be transmitted, the second determining unit 2022 may take into account the type of the file to be searched for, and further compare the first time point and time point of each record, which indicates at which time point a new file is obtained, so as to determine whether a record meeting the requirements exists or not.

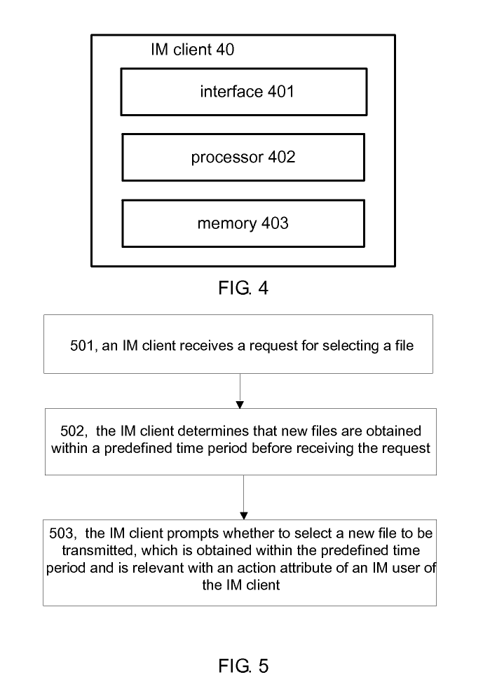

FIG. 4 is a block diagram illustrating structure of an IM client for prompting to select a new file, in accordance with an example of the present disclosure. As shown in FIG. 4, the IM client 40 may include an interface 401, a processor 402 and a memory 403.

Specifically speaking, the interface 401 is configured to receive a request for selecting a file to be transmitted. The memory 403 is configured to save an obtained file at real time. The processor 402 is configured to determine whether a new file is saved in the memory 403 within a predefined time period, before the interface 401 receives the request for selecting the file to be transmitted.

When determining the new file is saved in the memory 403 within the predefined time period, the processor 402 is further configured to obtain information of the new file from the memory 403, and prompt an IM user whether to select the new file to be transmitted, according to the obtained information of the new file.

Specifically speaking, the processor 402 is further configured to determine whether the request for selecting the file to be transmitted received by the interface 401 includes a type of the file. The type of the file may include at least one of: a picture, an audio, a video and a document.

In a first case, when determining the request for selecting the file to be transmitted received by the interface 401 includes a type of the file, such as the picture, the processor 402 is further configured to determine whether the new file of a same type, e.g., a new picture, is obtained within the predefined time period, before the interface 401 receives the request.

As a specific implementation mode, since the memory 403 may save a newly obtained file at real time, the processor 402 may determine whether a new file of the same type is saved into the memory 403 within the predefined time period, before the interface 401 receives the request for selecting the file to be transmitted. It should be noted that, how can the processor 402 determine whether the new file of the same type is obtained within the predefined time period, before the interface 401 receives the request is not limited to foregoing implementation mode.

When the processor 402 determines that a new file of the type same as that carried in the request received by the interface 401, the processor 402 may be further configured to obtain information of the corresponding new file from the memory 403, and provide the obtained information about the new file for an IM user using the IM client, so as to enable the IM user to determine whether to select the new file to be transmitted to another IM user.

Generally speaking, the predefined time period may be set according to practical requirements, such as 30 seconds, which is not limited here.

In the above case, when the processor 402 determines that the type of the file includes a picture, the processor 402 may be further configured to determine whether a new picture is saved in the memory 403 within the predefined time period, before the interface 401 receives the request for selecting the file to be transmitted.

When determining the new picture is saved in the memory 403 within the predefined time period, the processor 402 may be further configured to obtain a thumbnail from the memory 403, provide the thumbnail for the IM user, and prompt the IM user whether to select the new picture to be transmitted.

When the processor 402 determines that the type of the file includes at least one of an audio, a video and a document, the processor 402 may be further configured to determine whether a new file with the same type is saved in the memory 403 within the predefined time period, before the interface 401 receives the request for selecting the file to be transmitted.

When determining the new file of the same type is saved in the memory 403 within the predefined time period, such as, a new audio, a new video, a new document, the processor 402 may be further configured to obtain preview information of the corresponding new file from the memory 403, provide the corresponding preview information of the new file for the IM user, and prompt the IM user whether to select the new file to be transmitted.

In a second case, when the processor 402 determines that the request received by the interface 401 doesn't include the type of the file, the processor 402 may be further configured to determine whether a new file of any type, such as, a new picture, a new audio, a new video, a new document, is obtained within the predefined time period, before the interface 401 receives the request for selecting the file to be transmitted. For example, the processor 402 may determine whether a new file of any type is saved in the memory 403 within the predefined time period, before the interface 401 receives the request for selecting the file to be transmitted.

Under the circumstances that the processor 402 determines that a new file of any type is obtained within the predefined time period, before the interface 401 receives the request for selecting the file to be transmitted. The processor 402 may be further configured to obtain information about the new file from the memory 403, provide the obtained information about the new file for the IM user to be selected, so as to facilitate subsequent selection and transmission.

Similar to the first case, when the new file obtained within the predefined time period is a new picture, the processor 402 may obtain a thumbnail of the new picture from the memory 403, so as to prompt the IM user whether to select the new picture, according to the obtained thumbnail of the new picture. When the new file obtained within the predefined time period is a new audio, a new video, or a new document, the processor 402 may obtain corresponding preview information of the new file, so as to prompt the IM user whether to select the new file, according to the obtained preview information of the new file.

Subsequently, when the IM user selects the new file, according to the information about the new file obtained by the processor 402 from the memory 403, such as the thumbnail of a picture, or preview information of an audio, a video and a document, the new file may be rapidly selected and transmitted to another IM user subsequently via an IM server. When the IM user determines not to select the new file prompted by the processor 402, the IM user subsequently may select a file to be transmitted as technologies in the prior art, that is, the IM user may select a file from all of the files stored in the IM client 40.

For example, when an IM user wishes to select a picture and transmit the selected picture to another IM user, the IM user may select the picture from different albums, preview all of the pictures in each album, and then select the picture, which may increase the time period for selecting a picture. And the corresponding selection and transmission efficiency may be lower.

In the example illustrated with FIG. 4, the IM user may be a WeChat user, the IM client may be a WeChat client, and the IM server may be a WeChat server.

FIG. 5 is a flowchart illustrating another method for prompting to select a new file, in accordance with another example of the present disclosure. As shown in FIG. 5, the method may include the following blocks.

Block 501, an IM client receives a request for selecting a file to be transmitted.

Block 502, the IM client determines that new files are obtained within a predefined time period before receiving the request.

When the request for selecting the file to be transmitted received in block 501 includes a type of the file, the IM client may determine whether a new file of the same type is obtained within the predefined time period before receiving the request.

When the request for selecting the file to be transmitted received in block 501 doesn't include a type of the file, the IM client may determine whether a new file of any type is obtained within the predefined time period before receiving the request.

Block 503, the IM client prompts whether to select a new file to be transmitted, which is obtained within the predefined time period and is relevant with an action attribute of an IM user of the IM client.

Before executing foregoing block 503, the IM client may firstly determine the action attribute of the IM user of the IM client. Specifically speaking, the action attribute of the IM user of the IM client may include at least one of, but not limited to the following: a session topic of the IM user, a web browsing history, a topic of concern, contents about current session and hot news. Subsequently, the IM client may prompt whether to select the other new file obtained within the predefined time period to be transmitted.

To facilitate understanding, an example is provided in the following. During the process of an IM user of the IM client communicates with another IM user about news, in this case, the action attribute of the IM user of the IM client may be the session topic of the IM user. Subsequently, the IM client may determine that the session topic of the IM user is news.

And then, the IM client may determine whether there is a new file obtained within the predefined time period, which is relevant with the session topic of the IM user. When determining there is a new file obtained within the predefined time period is relevant with the session topic of the IM user, the IM client may firstly prompts the IM user of the IM client whether to select the new file relevant with the session topic of the IM user to be transmitted.

In the example, suppose the IM client determines that there are two pictures, which are respectively relevant with news and animals are obtained within the predefined time period. The IM client may firstly prompts the IM user of the IM client whether to select the picture about news to be transmitted. Subsequently, the IM client prompts whether to select the other new file about animals obtained within the predefined time period to be transmitted, in which the predefined time period may be set by an IM server, such as 30 seconds.

Subsequently, when the IM user determines to select the picture about news to be transmitted, no matter whether the IM user determines to select the picture about animals, rapid selection and transmission of the new picture may be implemented, and user experience may be improved.

By employing foregoing method and device for prompting to select a new file to be transmitted, such as a picture, an audio, a video and a document, selection and transmission of a new file may become more convenient, selection and transmission efficiency may be improved and user experience may also be greatly enhanced.

The figures are only illustrations of an example, wherein the modules or procedure shown in the figures are not necessarily essential for implementing the present disclosure. The modules in the aforesaid examples can be combined into one module or further divided into a plurality of sub-modules.

What is claimed is:

1. A method for prompting to select a new file in Instant Messaging (IM), comprising:
receiving, by an IM client, a request for selecting a file to be transmitted;
determining, by the IM client, a new file is obtained within a predefined time period before receiving the request; and
prompting, by the IM client, whether to select the new file to be transmitted.

2. The method according to claim 1, wherein when the request for selecting the file to be transmitted comprises a type of the file, determining by the IM client the new file is obtained within the predefined time period before receiving the request comprises:
determining, by the IM client, the new file of a same type is obtained within the predefined time period before receiving the request.

3. The method according to claim 1, wherein when the request for selecting the file to be transmitted doesn't comprise a type of the file, determining by the IM client the new file is obtained within the predefined time period before receiving the request comprises:
determining, by the IM client, the new file of any type is obtained within the predefined time period before receiving the request.

4. The method according to claim 2, wherein the type of the file comprises at least one of:
a picture, an audio, a video and a document.

5. The method according to claim 4, wherein when the type of the file comprises the picture, prompting by the IM client whether to select the new file to be transmitted comprises:
prompting, by the IM client, whether to select the new file to be transmitted in a manner of thumbnail.

6. The method according to claim 4, wherein when the type of the file comprises at least one of the audio, the video and the document, prompting by the IM client whether to select the new file to be transmitted comprises:
prompting, by the IM client, whether to select the new file to be transmitted in a manner of preview.

7. The method according to claim 1, wherein the predefined time period is 30 seconds.

8. The method according to claim 1, wherein the IM client is a WeChat client.

9. An Instant Messaging (IM) client for prompting to select a new file, comprising an interface, a processor and a memory, wherein
the interface is configured to receive a request for selecting a file to be transmitted,
the memory is configured to save an obtained file at real time,
the processor is configured to determine whether a new file is saved in the memory within a predefined time period, before the interface receives the request for selecting the file to be transmitted;
when determining the new file is saved in the memory within the predefined time period, the processor is further configured to obtain information of the new file from the memory, and prompt whether to select the new file to be transmitted, according to the obtained information of the new file.

10. The IM client according to claim 9, wherein when the request for selecting the file to be transmitted comprises a type of the file, the processor is configured to determine whether the new file of a same type is saved in the memory within the predefined time period, before the interface receives the request.

11. The IM client according to claim 9, wherein when the request for selecting the file to be transmitted doesn't comprise a type of the file, the processor is configured to determine whether the new file of any type is saved in the memory within the predefined time period, before the interface receives the request.

12. The IM client according to claim 10, wherein when the type of the file comprises a picture, the processor is configured to obtain a thumbnail of the picture, and prompt whether to select the picture, according to the obtained thumbnail of the picture.

13. The IM client according to claim 10, wherein when the type of the file comprises at least one of an audio, a video and a document, the processor is configured to obtain preview information of the new file, and prompt whether to select the new file, according to the obtained preview information of the new file.

14. The IM client according to claim 9, wherein the IM client is a WeChat client.

15. A method for prompting to select a new file in Instant Messaging (IM), comprising:
receiving, by an IM client, a request for selecting a file to be transmitted;
determining, by the IM client, new files are obtained within a predefined time period before receiving the request; and
prompting, by the IM client, whether to select a new file to be transmitted, which is obtained within the predefined time period and is relevant with an action attribute of an IM user of the IM client.

16. The method according to claim 15, further comprising:
before prompting by the IM client whether to select the new file to be transmitted, which is obtained within the predefined time period and is relevant with the action attribute of the IM user of the IM client, determining, by the IM client, the action attribute of the IM user of the IM client.

17. The method according to claim 15, wherein the action attribute of the IM user of the IM client comprises at least one of:
a session topic of the IM user, a web browsing history, a topic of concern, contents about current session and hot news.

18. The method according to claim 15, further comprising:
prompting, by the IM client, whether to select the other new file obtained within the predefined time period to be transmitted.

19. The method according to claim 15, wherein when the request for selecting the file to be transmitted comprises a type of the file, determining by the IM client the new files are obtained within the predefined time period before receiving the request comprises:
determining, by the IM client, the new files of a same type is obtained within the predefined time period before receiving the request.

20. The method according to claim 15, wherein when the request for selecting the file to be transmitted doesn't comprise a type of the file, determining by the IM client the new files are obtained within the predefined time period before receiving the request comprises:
determining, by the IM client, the new files of any type is obtained within the predefined time period before receiving the request.
